(19) United States
(12) Patent Application Publication
(10) Pub. No.: US 2010/0313428 A1
(43) Pub. Date: Dec. 16, 2010

(54) Multifunctional Plate Cutter

(75) Inventor: Viorel Mocanu, Lewisville, TX (US)

Correspondence Address: BAKER BOTTS L.L.P., 2001 ROSS AVENUE, SUITE 600, DALLAS, TX, 75201-2980, US

(73) Assignee: OsteoMed L.P., Addison, TX (US)

(21) Appl. No.: 12/483,403

(22) Filed: Jun. 12, 2009

(51) Int. Cl. B26B 19/04; B26B 9/00; B23P 11/00

(52) U.S. Cl. 30/193; 30/353; 29/428

(57) ABSTRACT

An apparatus for cutting a radial cut in a surgical plate includes a top jaw element, a bottom jaw element, a removable top insert operable to be coupled to the top jaw element, and a removable bottom insert operable to be coupled to the bottom jaw element, a first top radial cutting element and a second top radial cutting element coupled to the removable top insert, and a first bottom radial cutting element and a second bottom radial cutting element coupled to the removable bottom insert. The radial cutting elements provide a radial cut of the surgical plate. The apparatus also includes a first alignment post and a second alignment post coupled to the removable bottom insert. The alignment posts are operable to align the surgical plate on the removable bottom insert.

### TECHNICAL FIELD

The present disclosure relates generally to repairing bone fractures, and more particularly, to a multifunctional plate cutter.

### BACKGROUND

When repairing a broken or fractured bone, a physician may often utilize a metal plate that attaches to a patient's bone via screws. In many instances, the surgical plate must be cut so that it properly fits the patient's anatomy.

### SUMMARY

According to one embodiment of the present disclosure, an apparatus for cutting a radial cut in a surgical plate includes a top jaw element, a bottom jaw element, a removable top insert operable to be coupled to the top jaw element, and a removable bottom insert operable to be coupled to the bottom jaw element. The apparatus also includes a first top radial cutting element and a second top radial cutting element coupled to the removable top insert, and a first bottom radial cutting element and a second bottom radial cutting element coupled to the removable bottom insert. Each top radial cutting element has a first curved shape, and each bottom radial cutting element has a second curved shape corresponding to the first curved shape. The radial cutting elements provide a radial cut of the surgical plate. The apparatus also includes a first alignment post and a second alignment post coupled to the removable bottom insert. Each alignment post has a third shape having a third center. The alignment posts are operable to align the surgical plate on the removable bottom insert.

Certain embodiments of the disclosure may provide one or more technical advantages. A technical advantage of one embodiment may be that a radial cut may be made in a surgical plate instead of a straight cut. This allows for a surgical plate to better fit the anatomy of a patient. In addition, some embodiments may greatly reduce or eliminate burring on the cut of the surgical plate. This allows a physician to save critical time by not having to remove burrs on the cut of the surgical plate.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 illustrates an isometric view of an example embodiment of the present disclosure for cutting a radial cut in a surgical plate;

FIGS. 2A through 2C illustrate isometric views of example embodiments of removable inserts that may be coupled to the illustrated embodiment of FIG. 1; and

FIGS. 3A through 3C illustrate isometric views of additional example embodiments of removable inserts that may be coupled to the illustrated embodiment of FIG. 1; and

FIGS. 4A through 4D illustrate example cuts of surgical plates.

### DETAILED DESCRIPTION OF EXAMPLE EMBODIMENTS

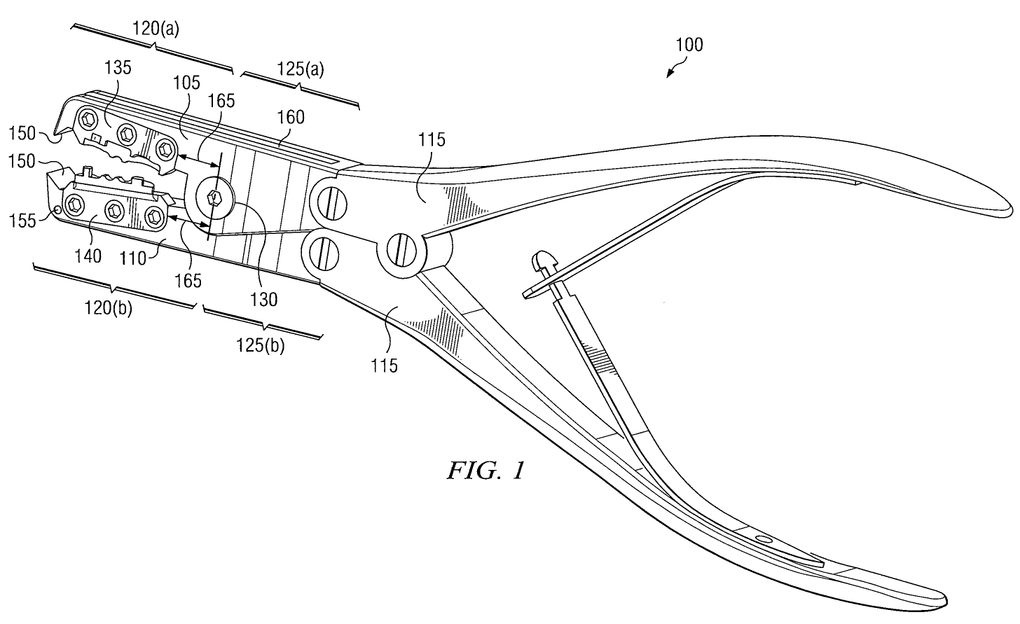

Embodiments of the present disclosure and its advantages are best understood by referring to FIGS. 1 through 4D of the drawings, like numerals being used for like and corresponding parts of the various drawings.

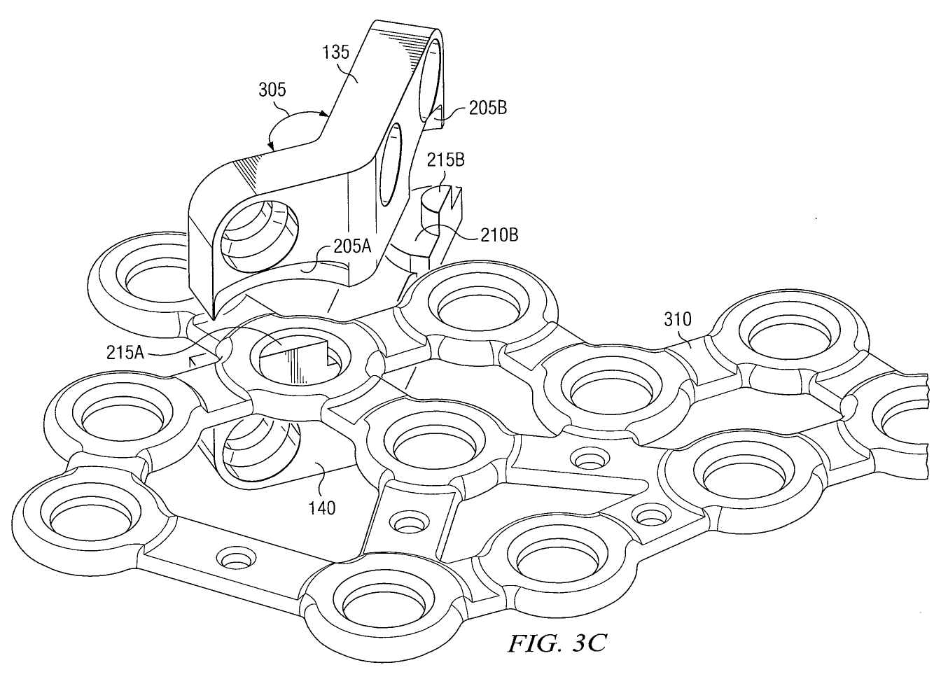

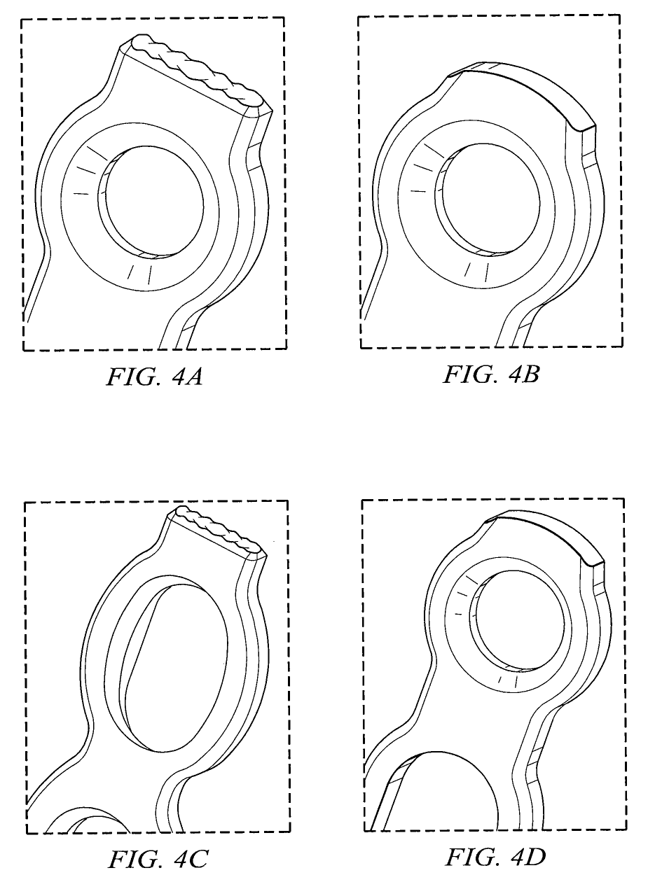

Surgical plates are often used to repair broken bones such as those in the hands and feet. In most circumstances, surgical plates need to be modified to fit the particular anatomy of a patient. To do this, a physician may utilize a cutting tool to cut away a portion of the surgical plate. Typical cutting tools, however, create straight cuts with significant burring on both the tissue and bone side of the surgical plate. (FIGS. 4A and 4C illustrate cuts performed by typical cutting tools.) As a result, the physician must resort to additional techniques such as filing to remove the burrs and further form the plates before attachment to the bone.

The teachings of the disclosure recognize that it would be desirable to provide a multifunctional plate cutter that produces radial cuts of surgical plates with little or no burring. FIGS. 1 through 4D below illustrate a multifunctional plate cutter according to the teachings of the disclosure.

FIG. 1 illustrates an isometric view of an example embodiment of a multifunctional plate cutter 100 that may be used to produce radial cuts of surgical plates with little or no burring. Multifunctional plate cutter 100 includes a top jaw element 105, a bottom jaw element 110, handles 115, and a pivot point 130. Top jaw element 105 and bottom jaw element 110 include a handle end 125, which is adjacent to handles 115, and a jaw end 120 on the opposite end from handle end 125. Top jaw element 105 and bottom jaw element 110 are coupled to each other at pivot point 130 between jaw end 120 and handle end 125.

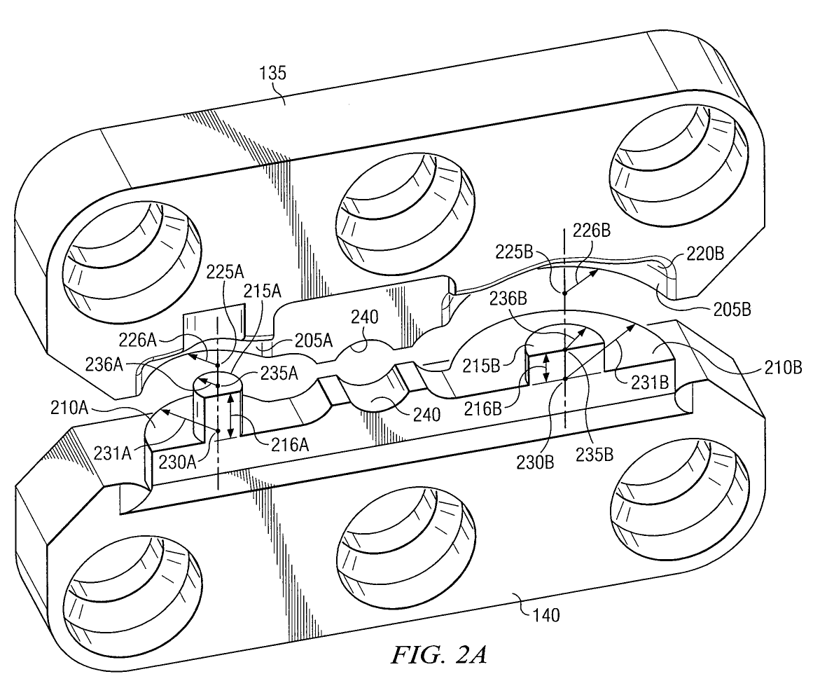

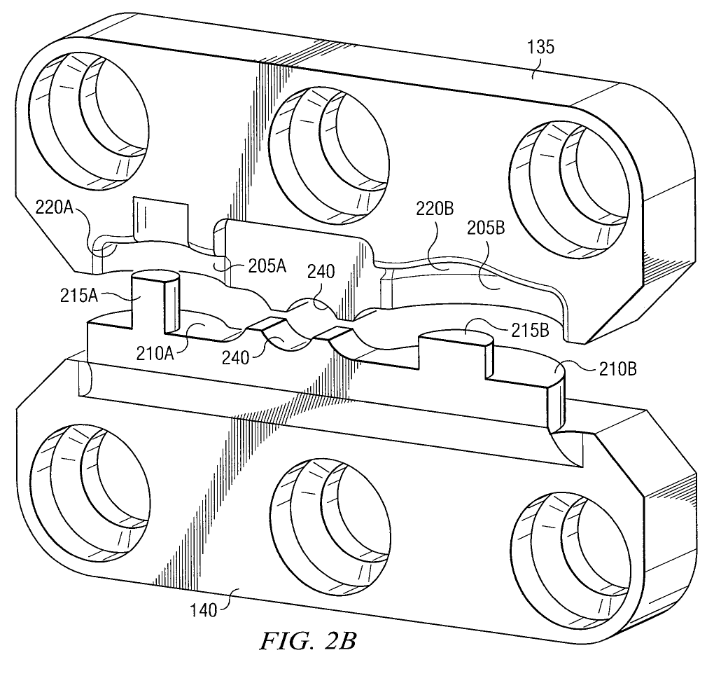

In operation, multifunctional plate cutter 100 produces radial cuts of surgical plates with little or no burring. To operate multifunctional plate cutter 100, a surgical plate is placed between top jaw element 105 and bottom jaw element 110 at jaw ends 120 while multifunctional plate cutter 100 is in the open position (multifunctional plate cutter 100 is shown in the open position in FIG. 1). Handles 115 may then be squeezed together in order to pivot top jaw element 105 and bottom jaw element 110 about pivot point 130 and cause jaw ends 120 to move towards each other. Radial cutting elements coupled to top jaw element 105 and bottom jaw element 110 at jaw ends 120 then contact and cut a radial cut in the surgical plate such as the radial cuts illustrated in FIGS. 4B and 4D. The radial cutting elements are described in more detail below in reference to FIGS. 2A through 2C.

In particular embodiments, multifunctional plate cutter 100 may include a removable top insert 135, a removable bottom insert 140, flush wire cutting elements 150, a void 155, and a file 160. Removable top insert 135 may be coupled to top jaw element 105 at jaw end 120(a), and removable bottom insert 135 may be coupled to bottom jaw element 110 at jaw end 120(b). Flush wire cutting elements 150 are coupled to jaw ends 120. Void 155 may be located at any feasible position on either jaw element 105 or 110. File 160 may be coupled to multifunctional plate cutter 100 at any feasible location.

Length 165 from pivot point 130 to inserts 135 and 140 may be any length to provide sufficient space between jaw elements 105 and 110 so that a surgical plate may be cut. In certain embodiments, length 165 may be between 0.01 and 0.5 inches. In other embodiments, length 165 may be between 0.03 and 0.2 inches. In a particular embodiment, length 165 may be approximately 0.1 inches.

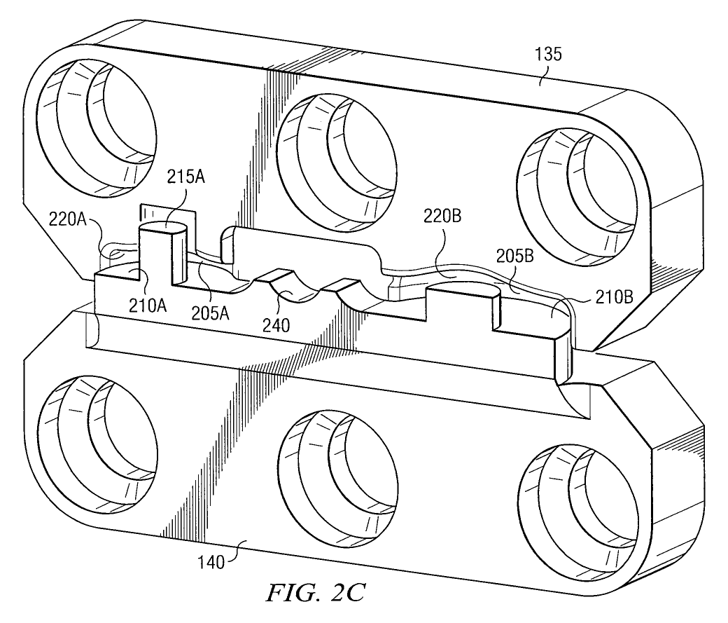

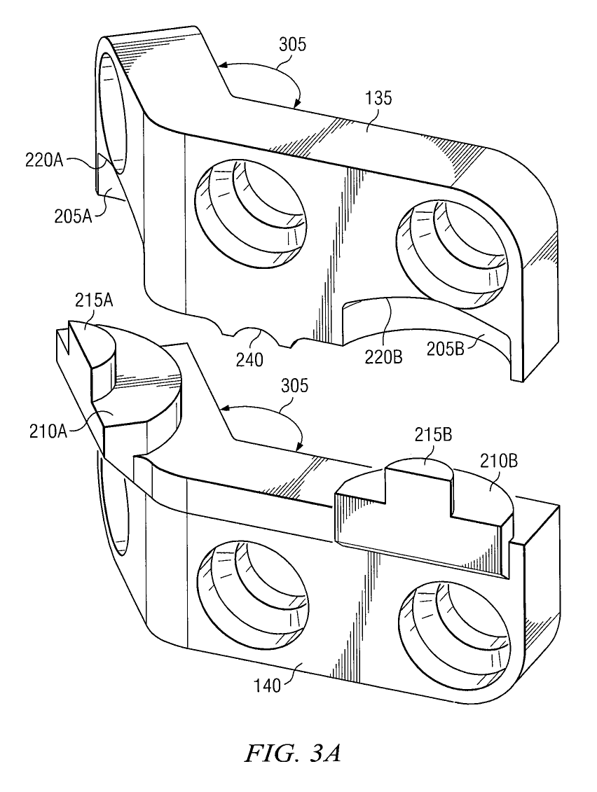

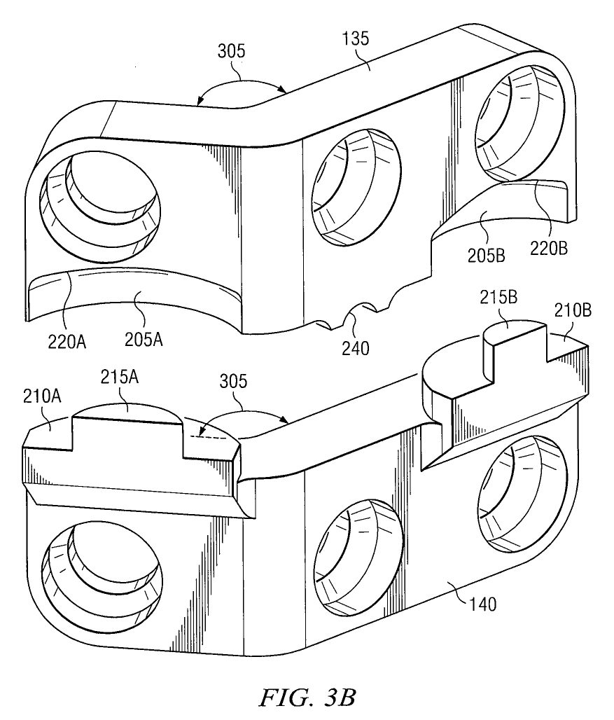

Removable top insert 135 and removable bottom insert 140 may be coupled to their respective jaw elements with fasteners and may be removed and replaced with alternate inserts. As shown in FIGS. 1 through 3C, removable inserts 135 and 140 may include one or more radial cutting elements for cutting different surgical plate sizes. Certain embodiments of removable top insert 135 and removable bottom insert 140 are described in more detail below in reference to FIGS. 2A through 3C.

In certain embodiments, flush wire cutting elements 150 may be provided to cut surgical wires such as Kirschner Wires (K-wires) close to a bone. To do so, a K-wire protruding from a bone may be placed between flush wire cutting elements 150 while multifunctional plate cutter 100 is in the open position. Jaw ends 120 of multifunctional plate cutter 100 may be placed close to or touching the bone from which the K-wire is protruding. Handles 115 may then be squeezed together in order to pivot top jaw element 105 and bottom jaw element 110 about pivot point 130 and cause jaw ends 120 to move towards each other. Flush wire cutting elements 150 then contact and cut the K-wire flush with the bone.

In particular embodiments, void 155 may be utilized to bend surgical wires such as K-wires. Void 155 may be any size to accommodate any surgical wires. To utilize void 155, an end of a K-wire is inserted into void 155. Multifunctional plate cutter 100 may then be rotated in any direction in order to bend the end of the K-wire into the desired shape.

In particular embodiments, file 160 may be utilized to reshape a surgical plate and/or remove any residual burring on a surgical plate. In some embodiments, file 160 may be located on top of top jaw element 105. Additionally or alternatively, file 160 may be located on the bottom of bottom jaw element 110, or any other suitable location on multifunctional plate cutter 100. File 160 may be any suitable file for filing surgical plates including, but not limited to, a diamond file.

FIGS. 2A through 2C illustrate isometric views of particular embodiments of removable top insert 135 and removable bottom insert 140. FIGS. 2A and 2B illustrate removable inserts 135 and 140 when multifunctional plate cutter 100 is in the open position. FIG. 2C illustrates removable inserts 135 and 140 when multifunctional plate cutter 100 is in the closed position. While elements of removable inserts 135 and 140 are described in more detail below, it should be noted that in particular embodiments, these elements may be coupled directly to jaw elements 105 and 110 instead of removable inserts 135 and 140. In addition, while inserts 135 and 140 are shown to include two cutting elements, certain embodiments may have one or more than two cutting elements.

In particular embodiments, removable inserts 135 and 140 include one or more top radial cutting elements 205, one or more bottom radial cutting elements 210, one or more alignment posts 215, one or more burr removal elements 220, and wire cutters 240. Top radial cutting elements 205 and burr removal elements 220 are coupled to the bottom side of removable top insert 135. Bottom radial cutting elements 210 and alignment posts 215 are coupled to the top side of removable bottom insert 140. Wire cutters 240 are coupled to both the bottom side of removable top insert 135 and the top side of removable bottom insert 140.

In operation, multifunctional plate cutter 100 produces radial cuts of surgical plates with radial cutting elements 205 and 210. To make a cut in a surgical plate, a surgical plate is placed on removable bottom insert 140 while multifunctional plate cutter 100 is in the open position. To allow a physician to quickly and accurately align the surgical plate, multifunctional plate cutter 100 provides alignment posts 215. The surgical plate may be placed on removable bottom insert 140 by aligning one of the alignment posts 215 with a screw hole in the surgical plate. Alignment posts 215 are described in more detail below.

After a surgical plate is placed on removable bottom insert 140, handles 115 may be squeezed together in order to pivot top jaw element 105 and bottom jaw element 110 about pivot point 130, thereby causing jaw ends 120 to move towards each other. Top radial cutting elements 205 and bottom radial cutting elements 210 then move towards each other and overlap as jaw ends 120 converge. As a result, a radial cut is made in the surgical plate. Radial cutting elements 205 and 210 are described in more detail below.

Top radial cutting elements 205 and bottom radial cutting elements 210 may be any radial shape having any practical size for cutting surgical plates. In a particular embodiment, for example, top radial cutting element 205(b) may have a curved shape such as a circle that has a center 225(b) and a radius 226(b) of approximately 0.135 inches. Likewise, bottom radial cutting element 210(b) may have a curved shape such as a circle that has a center 230(b) and a radius 231(b) of approximately 0.132 inches. Top radial cutting element 205(b) and bottom radial cutting element 210(b) may have similar shapes such that when handles 115 are squeezed, centers 225(b) and 230(b) align causing radial cutting element 205(b) and 210(b) to form concentric circles. As a result, top radial cutting element 205(b) may overlap bottom radial cutting element 210(b), much like the top and bottom portions of a pair of scissors, thus causing a radial cut in a surgical plate that has been placed on alignment post 215(b).

In certain embodiments, top radial cutting element 205(a) may have a curved shape such as a circle that has a center 225(a) and a radius 226(a) of approximately 0.090 inches. Bottom radial cutting element 210(a) may have a curved shape such as a circle that has a center 230(a) and a radius 231(a) of approximately 0.087 inches.

In certain embodiments, top radial cutting element 205 may have radius 226 of other sizes to produce larger or smaller radial cuts. For example, top radial cutting element 205 may have a radius 226 of between 0.080 and 0.250 inches. In other embodiments, top radial cutting element 205 may have radius 226 of between 0.090 and 0.150 inches.

In certain embodiments, bottom radial cutting element 210 may have radius 231 of other sizes to produce larger or smaller radial cuts. For example, bottom radial cutting element 210 may have a radius 231 of between 0.078 and 0.248 inches. In other embodiments, bottom radial cutting element 210 may have radius 231 of between 0.087 and 0.148 inches.

Alignment posts 215 may be any shape to allow a surgical plate to be aligned on multifunctional plate cutter 100. In certain embodiments, for example, alignment post 215(b) may be tubular in shape, having a center 235(b) and a radius 236(b) of approximately 0.046 inches to allow surgical plates with screw holes of approximately 2.0 mm-2.4 mm to be placed on alignment post 215(b). Alignment post 215(b) may have a height dimension 216(b) of approximately 0.041 inches.

In certain embodiments, alignment post 215(a) may be tubular in shape, having a center 235(a) and a radius 236(a) of approximately 0.028 inches to allow surgical plates with screw holes of approximately 1.2 mm-1.6 mm to be placed on alignment post 215(a). Alignment post 215(a) may have a height dimension 216(a) of approximately 0.060 inches.

In certain embodiments, alignment post 215 may have a radius 236 of other sizes to allow the alignment of surgical plates with larger or smaller screw holes. For example, alignment post 215 may have a radius 236 of between 0.020 and 0.125 inches. In other embodiments, alignment post 215 may have radius 236 of between 0.040 and 0.080 inches.

In certain embodiments, burr removal elements 220 may be included to control burring on radial cuts produced by multifunctional plate cutter 100. For example, burr removal elements 220 may be coupled to the upper areas of top radial cutting elements 205 and may have slightly smaller radii than radii 226, such as a radii of between 0.010 and 0.020 inches. As a result, burr removal elements 220 contact the surgical plate at the end of the cutting movement and may remove burrs created by top radial cutting elements 205. When a surgical plate is placed on multifunctional plate cutter 100 with the tissue side of the surgical plate facing top radial cutting elements 205, and the bone side of the surgical plate facing bottom radial cutting elements 210, burrs may be completely removed by burr removal elements 220 on the tissue side of the surgical plate, while minimal amount of burring may remain on the bone side of the surgical plate. This provides significant advantages over typical plate cutter because burring is undesirable on areas of surgical plates that contact tissue, while some burring is desirable on areas of surgical plates that contact bone in order to aid in positioning.

In certain embodiments, wire cutters 240 may be included to provide cutting of wires such as K-wires and/or Condylar tine. To cut a wire with wire cutters 240, a wire may be placed between wire cutters 240. Handles 115 may then be squeezed together in order to pivot top jaw element 105 and bottom jaw element 110 about pivot point 130 and cause jaw ends 120 to move towards each other. Wire cutters 240 then contact and cut the wire.

The elements of multifunctional plate cutter 100 may be formed of any suitable materials for cutting surgical plates. In certain embodiments, radial cutting elements 205(b) and 210(b), removable inserts 135 and 140, alignment posts 215, burr removal elements 220, and wire cutters 240 may be any stainless steel used in cutlery such as Crucible CPM S30V stainless steel that has been heat treated to around 62 HRC. In certain embodiments, jaw elements 105 and 110 may be 440 G stainless steel that has been heat treated to around 57 HRC.

FIGS. 3A through 3C illustrate isometric views of additional embodiments of removable top insert 135 and removable bottom insert 140. FIGS. 3A and 3B illustrate removable inserts 135 and 140 when multifunctional plate cutter 100 is in the open position. FIG. 3C illustrates removable inserts 135 and 140 when a surgical plate 310 is placed on alignment posts 215(a). Removable top insert 135 and removable bottom insert 140 as shown in FIGS. 3A through 3C may include some or all of the elements described previously in reference to FIGS. 2A through 2C.

In the embodiments illustrated in FIGS. 3A through 3C, removable top insert 135 and removable bottom insert 140 are angulated to allow the cutting of surgical plates such as surgical plate 310 shown in FIG. 3C that would otherwise be inaccessible to typical cutting tools. In certain embodiments, removable top insert 135 and removable bottom insert 140 may have an angle 305 of approximately 127 degrees. Other embodiments may have angle 305 of greater than or less than 127 degrees to allow the cutting of any shape of surgical plate 310. Certain embodiments of multifunctional plate cutter 100 may have altered jaw elements 105 and 110 and/or altered handles 115 (not shown) to accommodate angulated inserts 135 and 140 such as those illustrated in FIGS. 3A through 3C.

FIGS. 4A through 4D illustrate surgical plates that have been cut by various plate cutters. FIGS. 4A and 4C illustrate cuts performed by typical plate cutters. As shown in FIGS. 4A and 4C, typical plate cutters produce straight cuts with significant burring. These surgical plates would then need to be filed and shaped prior to attachment to a broken bone. FIGS. 4B and 4D, however, illustrate cuts that may have been performed by certain embodiments of multifunctional plate cutter 100. As illustrated in FIGS. 4B and 4D, multifunctional plate cutter 100 may provide radial cuts of surgical plates with little or no burring. As a result, surgical plates cut with multifunctional plate cutter 100 may be attached to a broken bone with little or no additional filing. This provides significant time savings to a physician.

Although the embodiments in the disclosure have been described in detail, numerous changes, substitutions, variations, alterations, and modifications may be ascertained by those skilled in the art. For example, FIG. 1 illustrates a certain embodiment of multifunctional plate cutter 100 having flush wire cutting elements 150, void 155, and file 160. Other embodiments of multifunctional plate cutter 100, however, may include some or none of these elements. Also, the size of multifunctional plate cutter 100 may be scaled up or down in order to accommodate various sizes of surgical plates. In addition, while FIGS. 2A through 3C illustrate removable inserts 135 and 140 having two sets of radial cutting elements 205 and 210, other embodiments may have one set or more than two sets. It is intended that the present disclosure encompass all such changes, substitutions, variations, alterations and modifications as falling within the spirit and scope of the appended claims.

What is claimed is:

1. An apparatus for cutting a surgical plate, the apparatus comprising:
a top jaw element and a bottom jaw element, each jaw element comprising a jaw end and a handle end, the jaw elements coupled to each other at a pivot point between the jaw ends and the handle ends, the jaw elements operable to pivot about the pivot point from an open position to a closed position, the jaw ends being substantially adjacent to one another in the closed position;
a top radial cutting element coupled to the top jaw element, the top radial cutting element comprising a first curved shape, the first curved shape having a first center;
a bottom radial cutting element coupled to the bottom jaw element, the bottom radial cutting element comprising a second curved shape corresponding to the first curved shape, the second curved shape having a second center; and
an alignment post coupled to the bottom jaw element and operable to align the surgical plate on the bottom jaw element, the alignment post comprising a third shape, the third shape having a third center;
wherein, in the closed position, the first, second, and third centers substantially align, and the top radial cutting element substantially overlaps the bottom radial cutting element, thereby providing a radial cut of a surgical plate.

2. The apparatus of claim 1, further comprising:
a removable top insert operable to be coupled to the jaw end of the top jaw element; and
a removable bottom insert operable to be coupled to the jaw end of the bottom jaw element; and
wherein the top radial cutting element is coupled to the removable top insert, and the bottom radial cutting element is coupled to the removable bottom insert.

3. The apparatus of claim 1, wherein the top radial cutting element further comprises a burr removal element, the burr removal element comprising a fourth curved shape and operable to reduce burring on the radial cut of the surgical plate.

4. The apparatus of claim 1, further comprising a file operable to reduce burring on the radial cut.

5. The apparatus of claim 1, further comprising flush wire cutting elements coupled to the jaw ends of the jaw elements, wherein the flush wire cutting elements substantially contact each other in the closed position thereby providing cutting of wires flush with bone surfaces.

6. The apparatus of claim 1, further comprising a void operable to receive an end of a wire, the void further operable to bend the wire in response to rotation of the apparatus.

7. The apparatus of claim 1, wherein the apparatus is operable to cut surgical plates having screw sizes selected from the group consisting of 1.2 millimeters (mm), 1.6 mm, 2.0 mm, and 2.4 mm.

8. The apparatus of claim 2, wherein the removable top insert and the removable bottom insert comprise an angulated shape having an angle of approximately 127 degrees.

9. A method for forming an apparatus for cutting a surgical plate, comprising:
forming a top jaw element and a bottom jaw element, each jaw element comprising a jaw end and a handle end, the jaw elements coupled to each other at a pivot point between the jaw ends and the handle ends, the jaw elements operable to pivot about the pivot point from an open position to a closed position, the jaw ends being substantially adjacent to one another in the closed position;
forming a top radial cutting element coupled to the top jaw element, the top radial cutting element comprising a first curved shape, the first curved shape having a first center;
forming a bottom radial cutting element coupled to the bottom jaw element, the bottom radial cutting element comprising a second curved shape corresponding to the first curved shape, the second curved shape having a second center; and
forming an alignment post coupled to the bottom jaw element and operable to align the surgical plate on the bottom jaw element, the alignment post comprising a third shape, the third shape having a third center;
wherein in the closed position, the first, second, and third centers substantially align, and the top radial cutting element substantially overlaps the bottom radial cutting element, thereby providing a radial cut of a surgical plate.

10. The method of claim 9, further comprising:
forming a removable top insert operable to be coupled to the jaw end of the top jaw element; and
forming a removable bottom insert operable to be coupled to the jaw end of the bottom jaw element; and
wherein the top radial cutting element is coupled to the removable top insert, and the bottom radial cutting element is coupled to the removable bottom insert.

11. The method of claim 9, further comprising forming a burr removal element, the burr removal element coupled to the top radial cutting element, the burr removal element comprising a fourth curved shape and operable to reduce burring on the radial cut of the surgical plate.

12. The method of claim 9, further comprising forming a file coupled to the apparatus, the file operable to reduce burring on the radial cut.

13. The method of claim 9, further comprising forming flush wire cutting elements coupled to the jaw ends of the jaw elements, wherein the flush wire cutting elements substantially contact each other in the closed position thereby providing cutting of wires flush with bone surfaces.

14. The method of claim 9, further comprising forming a void coupled to the apparatus, the void operable to receive an end of a wire and to bend the wire in response to rotation of the apparatus.

15. The method of claim 9, wherein the apparatus is operable to cut surgical plates having screw sizes selected from the group consisting of 1.2 millimeters (mm), 1.6 mm, 2.0 mm, and 2.4 mm.

16. The method of claim 10, wherein the removable top insert and the removable bottom insert comprise an angulated shape having an angle of approximately 127 degrees.

17. An apparatus for cutting a radial cut in a surgical plate, the apparatus comprising:
a top jaw element and a bottom jaw element;
a removable top insert operable to be coupled to the top jaw element;
a removable bottom insert operable to be coupled to the bottom jaw element;
a first top radial cutting element and a second top radial cutting element coupled to the removable top insert, each top radial cutting element comprising a first curved shape;
a first bottom radial cutting element and a second bottom radial cutting element coupled to the removable bottom insert, each bottom radial cutting element comprising a second curved shape corresponding to the first curved shape; and
a first alignment post and a second alignment post coupled to the removable bottom insert and operable to align the surgical plate on the removable bottom insert, each alignment post comprising a third shape, the third shape having a third center;
wherein the radial cutting elements provide a radial cut of a surgical plate.

18. The apparatus of claim 17, wherein the top radial cutting element further comprises a burr removal element, the burr removal element comprising a fourth curved shape and operable to reduce burring on the radial cut of the surgical plate.

19. The apparatus of claim 17, further comprising a file operable to reduce burring on the radial cut.

20. The apparatus of claim 17, further comprising flush wire cutting elements coupled to the jaw elements, wherein the flush wire cutting elements providing cutting of wires flush with bone surfaces.

21. The apparatus of claim 17, further comprising a void operable to receive an end of a wire, the void further operable to bend the wire in response to rotation of the apparatus.

22. The apparatus of claim 17, wherein the apparatus is operable to cut surgical plates having screw sizes selected from the group consisting of 1.2 millimeters (mm), 1.6 mm, 2.0 mm, and 2.4 mm.

23. The apparatus of claim 17, wherein:
the first top radial cutting element comprises a circle having a radius of approximately 0.090 inches;
the first bottom radial cutting element comprises a circle having a radius of approximately 0.087 inches;
the first alignment post comprises a circle having a radius of approximately 0.028 inches;
the second top radial cutting element comprises a circle having a radius of approximately 0.135 inches;
the second bottom radial cutting element comprises a circle having a radius of approximately 0.132 inches; and
the second alignment post comprises a circle having a radius of approximately 0.046 inches;

24. The apparatus of claim 17, wherein the removable top insert and the removable bottom insert comprise an angulated shape having an angle of approximately 127 degrees.
